(19) United States
(12) Patent Application Publication
(10) Pub. No.: US 2011/0063970 A1
(43) Pub. Date: Mar. 17, 2011

(54) MOVING APPARATUS AND INFORMATION RECORDING/REPRODUCING APPARATUS

(75) Inventor: Koichi Yaeguchi, Kanagawa (JP)

(73) Assignee: PIONEER CORPORATION, Kawasaki-shi, Kanagawa (JP)

(21) Appl. No.: 12/934,136

(22) PCT Filed: Mar. 28, 2008
(86) PCT No.: PCT/JP2008/056030

§ 371 Date: Dec. 3, 2010

(51) Int. Cl. G11B 3/00; H02N 2/04

(52) U.S. Cl. 369/144; 310/323.02; G9B/9

(57) ABSTRACT

A drive (1) for driving an object to be driven (14) in a predetermined direction comprises a plurality of guide means (18) which are fixed to a substrate (11) and extend in a predetermined direction, respectively, output means (2) for outputting the driving force in the direction along the direction in which the plurality of guide means extend from an output terminal section (20) to at least one of the plurality of guide means and advancing with the object to be driven in parallel by being coupled to the object to be driven, and a control means (100) for controlling each of a plurality of output means so that the plurality of output means output the drive force at a desired time.

### TECHNICAL FIELD

The present invention relates to a drive apparatus using an ultrasonic motor, which drives an optical pickup and another driven object in an extending direction of a guide shaft, and an information recording/reproducing apparatus.

### BACKGROUND ART

As this type of drive apparatus, generally, there is known a drive apparatus using an electromagnetic motor. However, due to the rotation output of the electromagnetic motor, when the driven object is driven along the guide shaft, it is necessary to provide an engagement gear mechanism in order to change the output of the electromagnetic motor from the rotational direction to the extending direction of the guide shaft. The gear mechanism, however, causes a noise from the engagement part at the time of the drive.

Thus, a drive apparatus using an ultrasonic motor is suggested in patent documents 1 to 5 in order to output a driving force in the extending direction of the guide shaft from the beginning.

However, for example, the following problems could occur in the technologies disclosed in the patent documents 1 to 5 described above.

In the patent documents 1 to 4, the ultrasonic motor has a substrate-fixed structure in which it is fixed not to a displaced object but to the substrate side provided with the guide shaft, so a relative positional relation changes between the displaced object and the ultrasonic motor. Thus, as the displaced object gets away from the ultrasonic motor, the deflection of the guide shaft increases, and it changes a pressing pressure (i.e. driving force) by the ultrasonic motor. Hence, there is a possibility that the stable drive cannot be maintained.

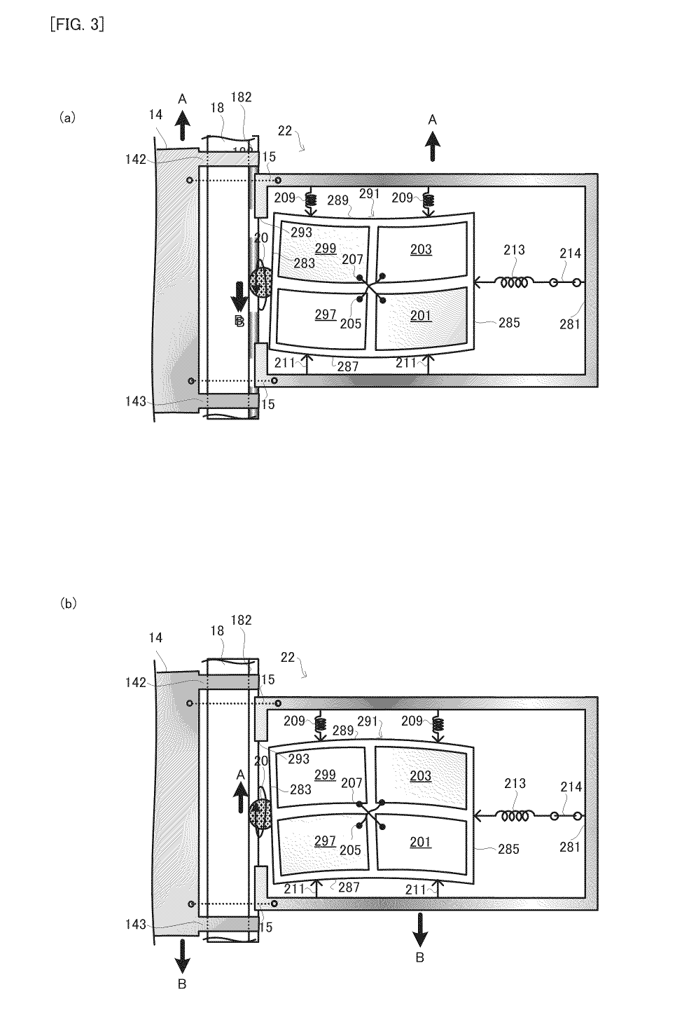

In contrast, in the patent document 1, the ultrasonic motor has a displaced-object-fixed structure in which it is fixed to the displaced object, so the relative positional relation does not change between the displaced object (which is, in this case, an optical pickup 5) and the ultrasonic motor. According to FIG. 3 in the patent document 5, however, there is provided only one ultrasonic motor (refer to a reference numeral LM), so that the driving force is hardly ensured. In particular, as the ultrasonic motor directly outputs the driving force to only one of two guide shafts (refer to reference numerals 1), the other is dragged. This can cause a loss of the driving force. Patent document 1: Japanese Patent Application Laid Open No. Hei 9-35433 Patent document 2: Japanese Patent Application Laid Open No. Hei 9-91891 Patent document 3: Japanese Patent Application Laid Open No. 2002-367299 Patent document 4: Japanese Patent Application Laid Open No. 2002-367300 Patent document 5: Japanese Utility Model Application Laid Open No. Hei 2-060963

### DISCLOSURE OF INVENTION

### Subject to be Solved by the Invention

In view of the aforementioned problems, it is therefore an object of the present invention to provide, for example, a drive apparatus which reduces a noise and which can maintain stable drive with a sufficient driving force when driving a driven object, and an information recording/reproducing apparatus.

### Means for Solving the Subject

The above object of the present invention can be achieved by a drive apparatus for driving a driven object in a predetermined direction, the drive apparatus provided with: a plurality of guiding devices which are fixed to a substrate and each of which extends in the predetermined direction; a plurality of outputting devices each of which outputs a driving force in a direction along the extending direction of the guiding devices from an output end to at least one of the plurality of guiding devices and which are translated with the driven object by being connected to the driven object; and a controlling device for controlling each of the outputting devices such that the outputting devices outputs the driving force in desired timing.

According to the drive apparatus of the present invention, the following operation makes it possible to preferably drive the driven object in the predetermined direction.

Each of the plurality of guiding devices is fixed to the substrate on its both ends, on its one end, or in another portion, extends in the predetermined direction, and supports the displacement or slide of the driven object. The “predetermined direction” is a direction determined in advance as a direction in which it is desired to drive the driven object, or a direction which can be changed, as occasion demands, in operation. Moreover, the “predetermined direction” includes not only a linear direction but also a curved direction.

Each of the plurality of outputting devices outputs the driving force in the direction along the extending direction of the guiding devices, from an of output end to at least one of the plurality of guiding devices. The “outputting device” is, for example, an ultrasonic motor for outputting the driving force in the following principle. The ultrasonic motor is, for example, a motor for applying a high-frequency alternating current voltage in an ultrasonic range to a piezoelectric element and for outputting elliptic motion obtained by synthesizing longitudinal resonance motion and lateral resonance motion, which are caused by the resonance of the frequency, from the output end as the driving force. Incidentally, the “outputting device” is not limited to the device that operates in this principle as long as it can output the driving force in the direction along the extending direction of the guiding devices. Moreover, the outputting device is translated with the driven object by being connected to the driven object inside or outside thereof. In other words, the outputting device adopts a displaced-object-fixed structure, so that the outputting device is translated with the driven object while the driven object is driven. This does not change a relative positional relation between the displacement object and the outputting device, which makes it possible to prevent the deflection of the guiding device, thereby maintaining stable drive. Incidentally, the driven object and the outputting device are connected, for example, by a spiral, a spring, an adhesive, a weld, or the like.

The controlling device is provided, for example, with an arithmetic apparatus and a memory apparatus, and it controls each of the plurality of outputting devices such that the plurality of outputting devices output the driving force in the desired timing, by transmitting a drive control signal indicating the strength (or ON/OFF) of the driving force and its output timing to each outputting device. This makes it possible to control each outputting device individually.

As described above, according to the drive apparatus of the present invention, it can maintain the stable drive while reducing a noise when the driven object is driven. In particular, as the plurality of outputting devices are provided, it is possible to ensure the sufficient driving force. Moreover, each outputting device is appropriately placed and individually controlled, so that it is possible to avoid a loss of the driving force as much as possible.

In one aspect of the drive apparatus of the present invention, the plurality of outputting deices output the driving force to two of the plurality of guiding devices which make a pair.

According to this aspect, the driving force is outputted to two of the plurality of guiding devices which make a pair. Thus, it is possible to maintain the stable drive in comparison with a case where the driving force is outputted to only one guiding device.

In the aforementioned one aspect, the drive apparatus may be further provided with a biasing device for biasing the plurality of outputting deices toward side surfaces of the two guiding devices which make a pair, and a direction in which the plurality of outputting deices are biased toward the side surface of one of the two guiding devices which make a pair may be opposite to a direction in which the plurality of outputting deices are biased toward the side surface of the other guiding device.

According to this aspect, the biasing device applies a force to the plurality of outputting devices toward the side surfaces of the two guiding devices which make a pair. This allows the driving force to be transmitted steadily even if a contact area between the side surface of the guiding device and the output end of the outputting device is extremely small. In particular, the direction in which the outputting deices are biased toward the side surface of the one guiding device is opposite to the direction in which the outputting deices are biased toward the side surface of the other guiding device. Thus, the driven object and the plurality of outputting devices are translated with it propped between the two guiding devices which make a pair. This makes it possible to output a proper balance of the driving force to the two guiding devices which make a pair. Incidentally, the biasing device may be a mechanism (manual/FB control) capable of releasing the bias if necessary, as occasion demands). Incidentally, there may be a plurality of pairs made by the “two guiding devices”, which indicates, in effect, that the pair may be made by three or more guiding devices.

Alternatively, in the aforementioned one aspect, each of the two guiding devices which make a pair may be a guide shaft in which a plane is formed in the extending direction of the guiding devices in at least one portion of the side surface.

According to this aspect, the plurality of outputting devices connected to the driven object are caught between the planes formed on the two guiding devices which make a pair, from the both sides. Then, if the output end of each outputting device is planar and is in plane contact with each of the planes, then, it is possible to maintain the parallel, good contact state. Moreover, if each output end is spherical and is in point contact with each of the planes, then, a shift of rotation can be prevented. Incidentally, the guide shaft may be, for example, a polygonal column such as a triangular prism and a quadrangular prism, or a column with a D cut surface. The “plane” described herein includes not only a plane in a strict sense but also a curved surface with a small curvature and a slightly uneven surface in a broad sense, as long as the driving force can be transmitted from the output end of the outputting device.

Alternatively, in the aforementioned one aspect, each of the two guiding devices which make a pair may be a side wall of the substrate having two planes which are parallel to each other and which are formed in a direction along the predetermined direction.

According to this aspect, the side wall in one portion of the substrate is used instead of the guide shaft, so that the guide shaft and its fixing member are not necessary. Then, it is possible to reduce the number of parts and simplify the structure.

In another aspect of the drive apparatus of the present invention, the controlling device controls each of the plurality of outputting devices such that the plurality of outputting devices output the driving force all together.

According to this aspect, as the plurality of outputting devices output the driving force all together, the overall driving force improves.

In another aspect of the drive apparatus of the present invention, the controlling device controls each of the plurality of outputting devices such that the plurality of outputting devices output the driving force alternately.

According to this aspect, as the plurality of outputting devices output the driving force alternately, it is possible to maintain the stable drive in comparison with the case where the driving force is outputted to only one guiding device.

In the aspect in which the plurality of outputting devices output the driving force alternately as described above, the drive apparatus may be further provided with a biasing device for biasing the plurality of outputting deices toward at least one of the plurality of guiding devices, and the controlling device may also control the biasing device not to bias an outputting device that does not the driving force when the plurality of outputting devices output the driving force alternately.

According to this aspect, while the driving force is not outputted, the bias is released. Thus, it is possible to avoid the output end of the outputting device being worn away unnecessarily.

In another aspect of the drive apparatus of the present invention, the plurality of outputting devices are arranged side by side in the direction along the extending direction of the guiding devices.

According to this aspect, it is possible to limit or control the thickness of the drive apparatus in a direction crossing the extending direction of the guiding devices.

In another aspect of the drive apparatus of the present invention, the plurality of outputting devices are arranged in piles in a direction crossing the extending direction of the guiding devices.

According to this aspect, it is possible to increase the driving force per unit length in the direction along the extending direction of the guiding devices. Moreover, it is possible to reduce an area occupied by the outputting devices, viewed from the above of the direction crossing the extending direction of the guiding devices.

The above object of the present invention can be also achieved by an information recording/reproducing apparatus, wherein the outputting devices are ultrasonic motors, the driven object is a pickup apparatus, and the drive apparatus is used as a feed mechanism of the pickup apparatus.

According to this aspect, it is possible to reduce a noise and maintain the stable drive when the pickup apparatus is driven upon information recording or reproduction by the information recording/reproducing apparatus. Incidentally, the information recording/reproducing apparatus is, for example, an apparatus which can realize at least one of a function of recording information onto a recording medium and a function of reproducing the information recorded on the recording medium. The pickup apparatus is an apparatus provided with a laser light source for performing the information recording or reproduction on the recording medium such as a CD (Compact Disc), a DVD, or a BD (Blu-ray Disc); and a light receiving part. Incidentally, the recording medium is not limited to a disc-shaped medium; its aspect is not particularly considered as long as there is a need to drive the pickup apparatus in the predetermined direction. Incidentally, even the information recording/reproducing apparatus of the present invention can correspond to the various aspects of the drive apparatus of the present invention described above.

These operation and other advantages of the present invention will become more apparent from the embodiments explained below.

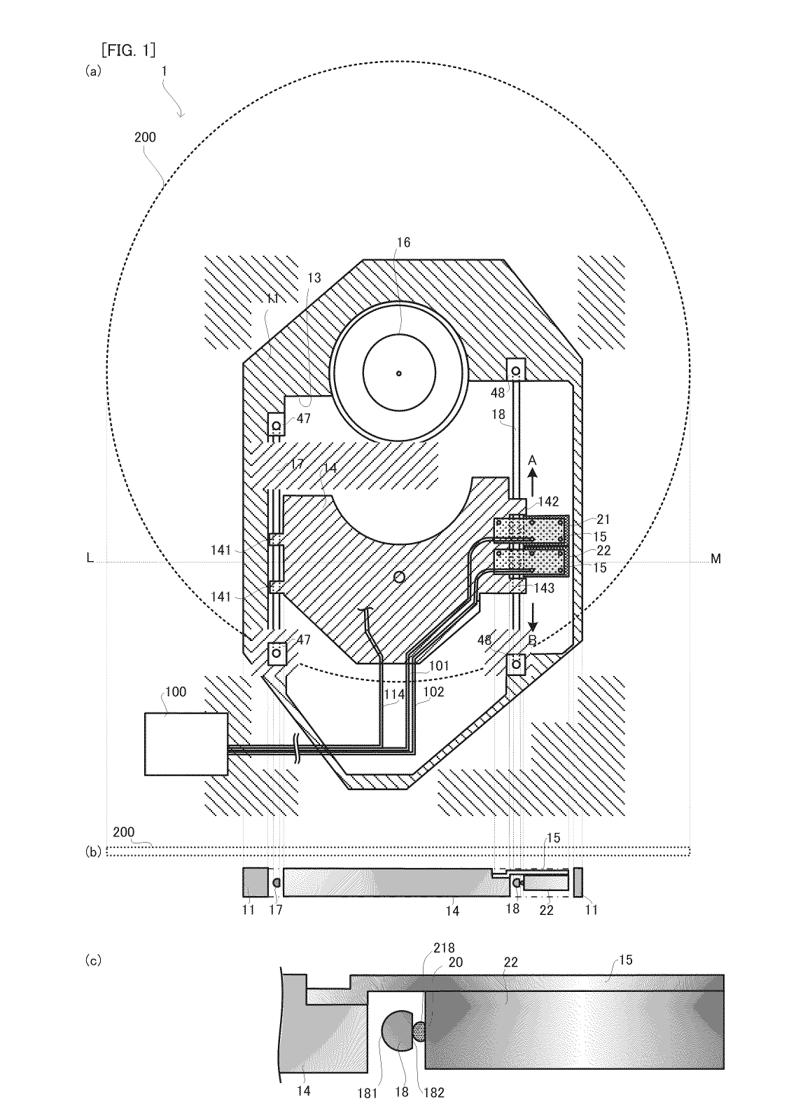

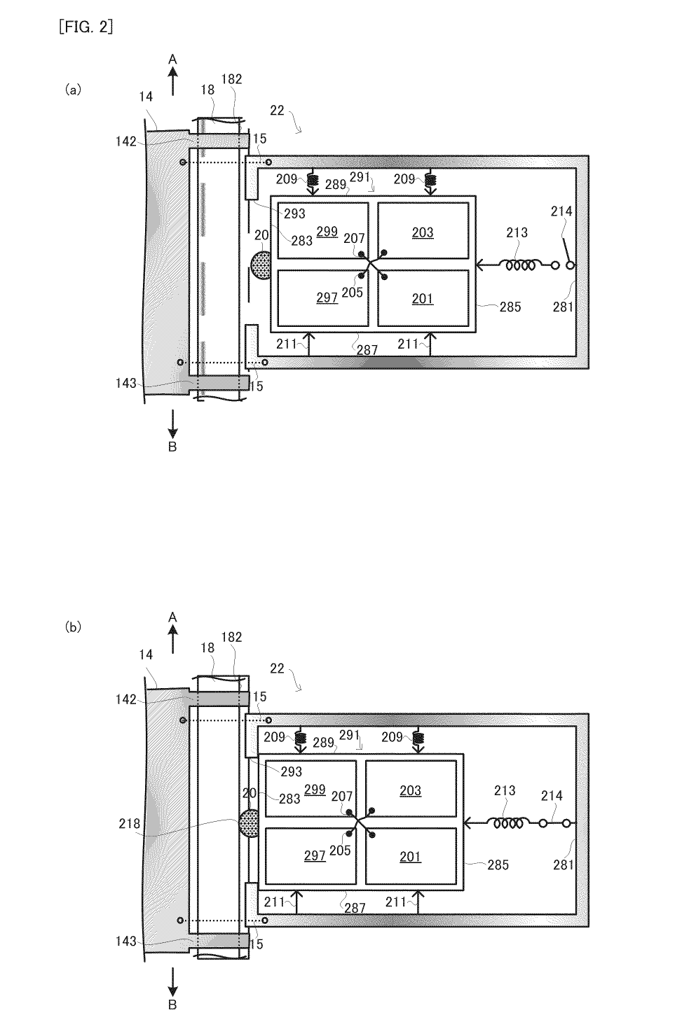

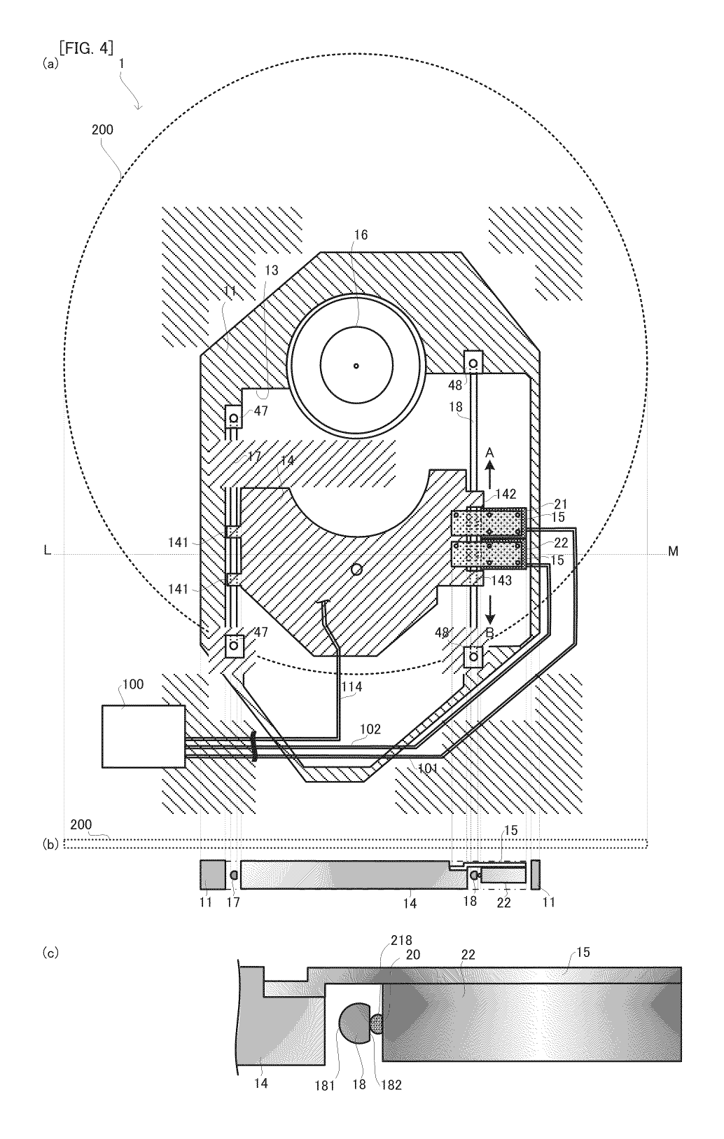

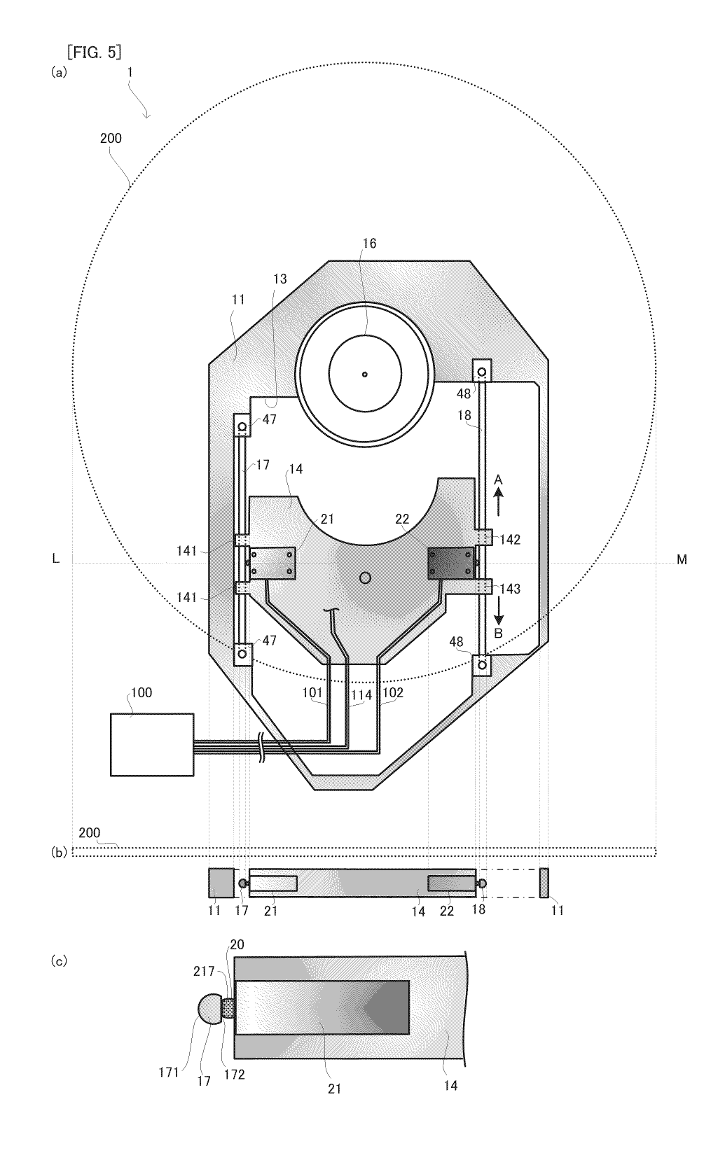

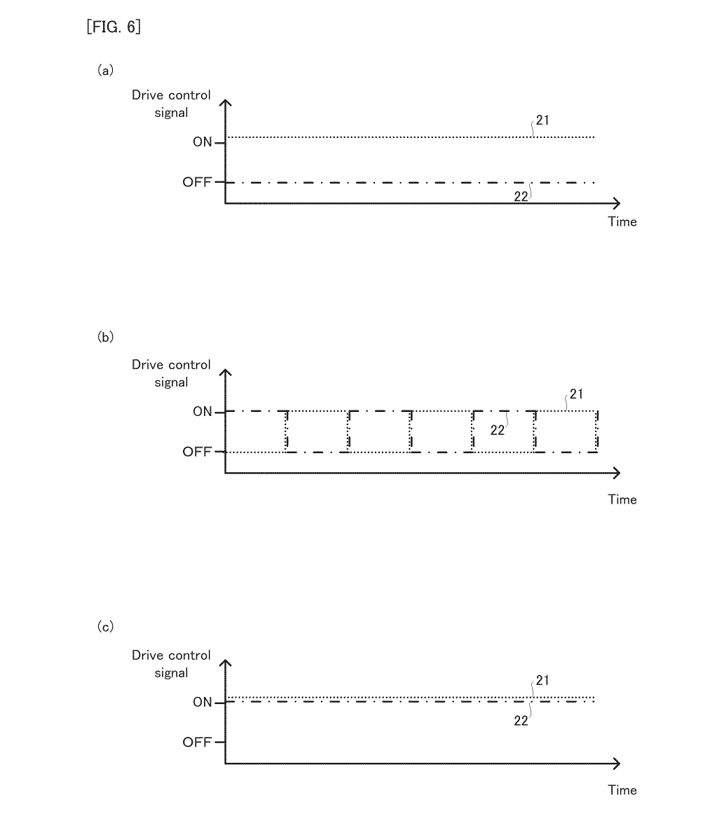

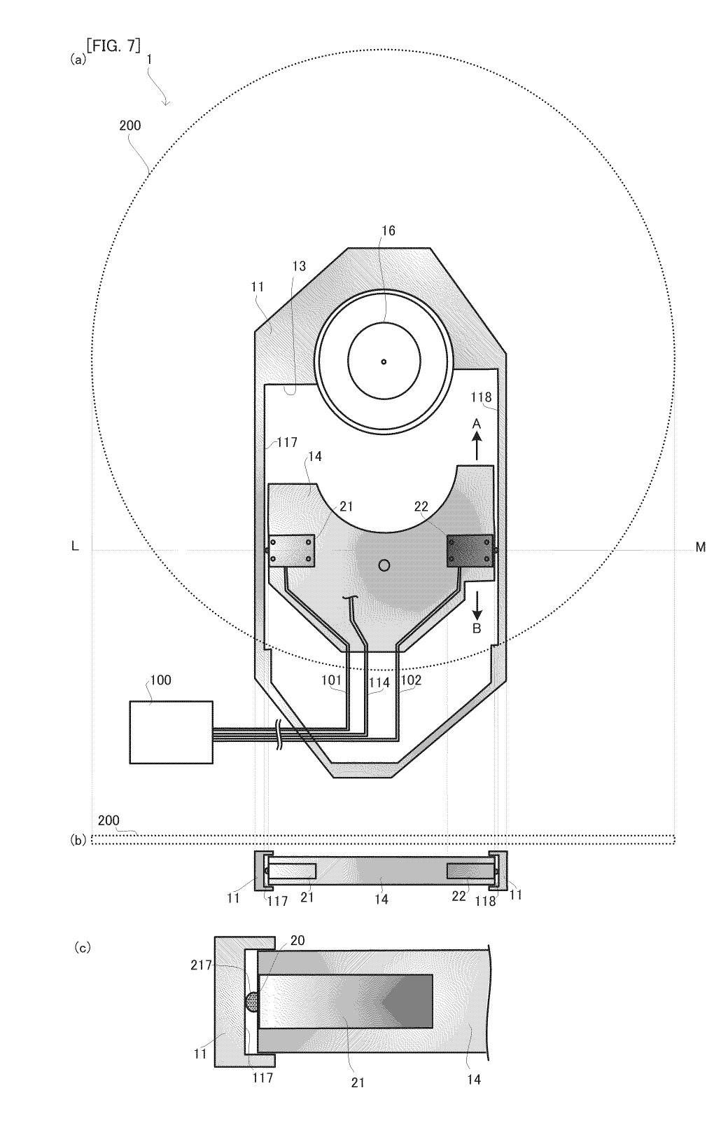

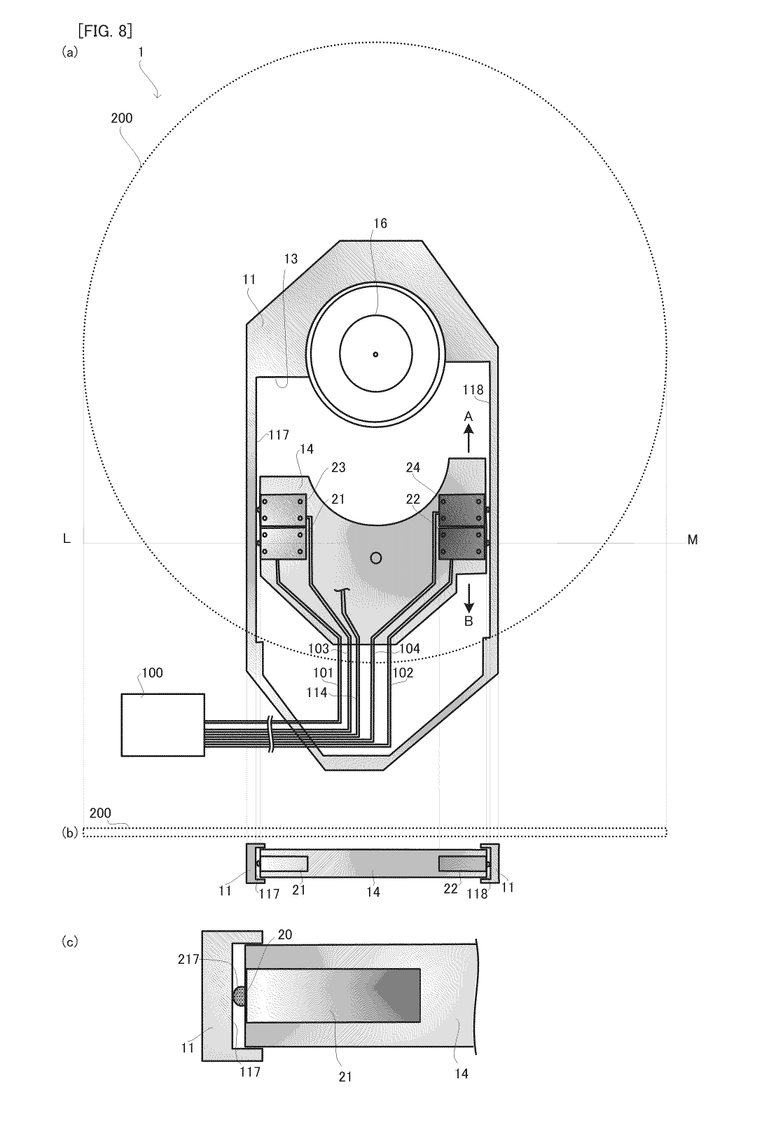

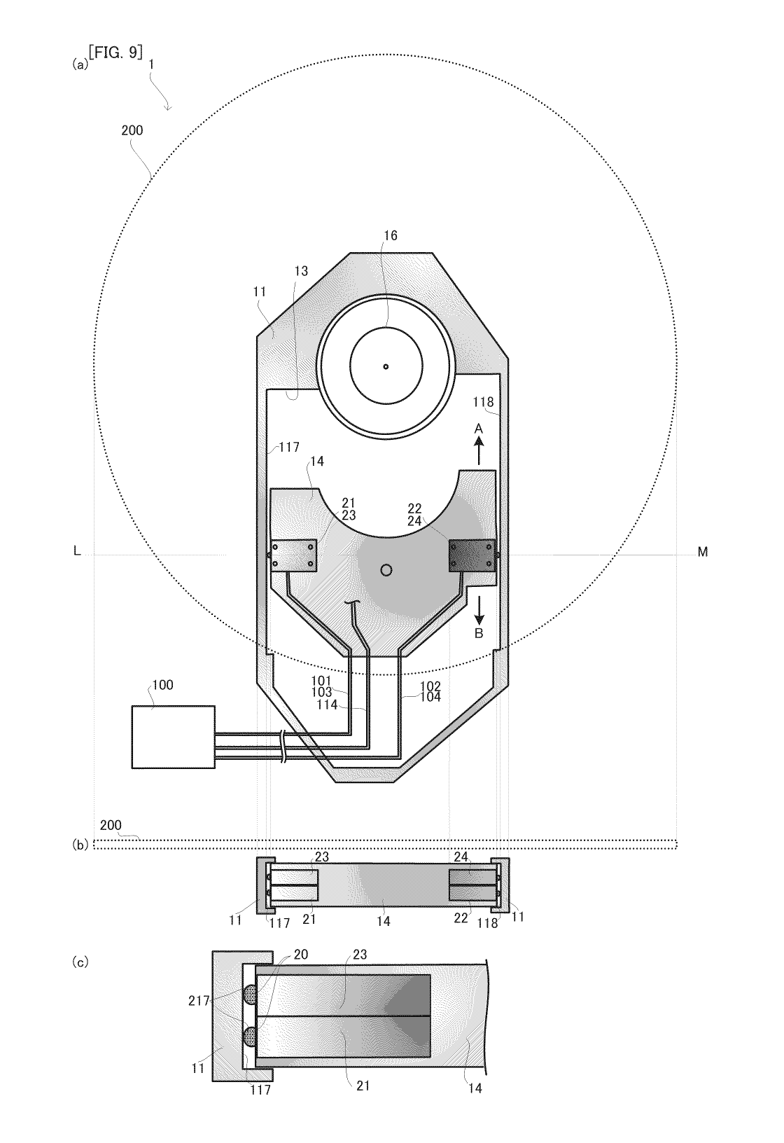

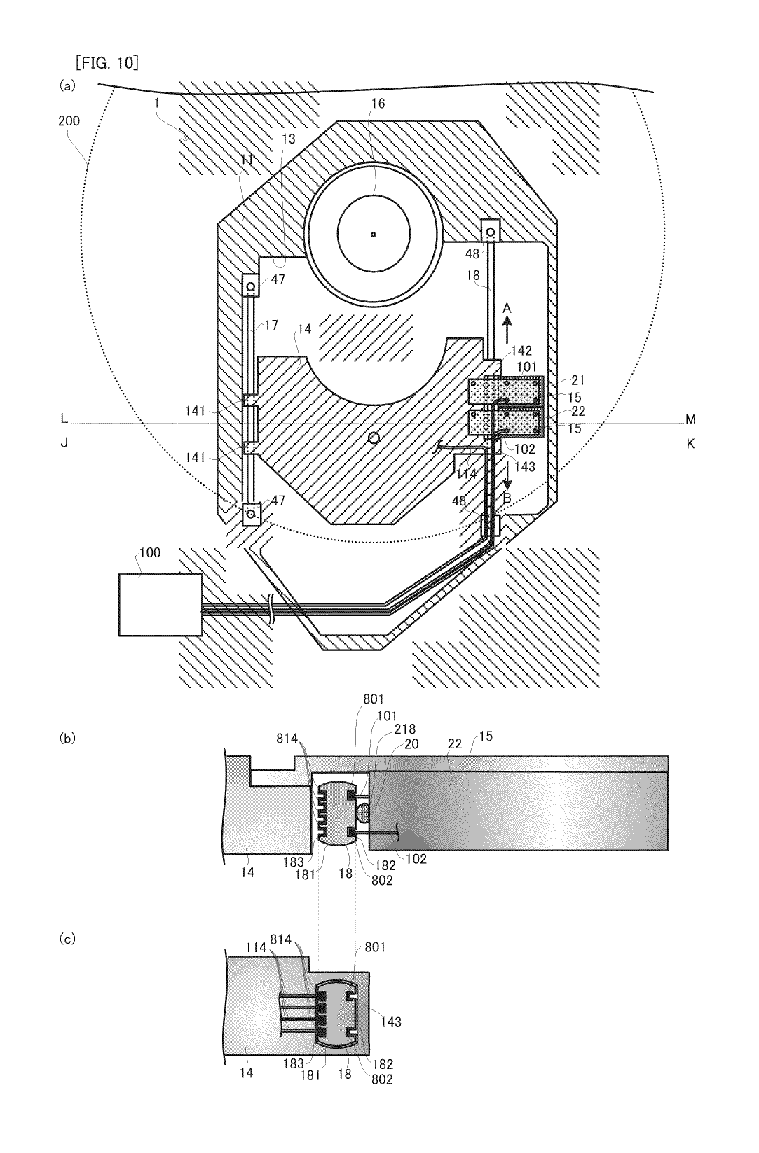

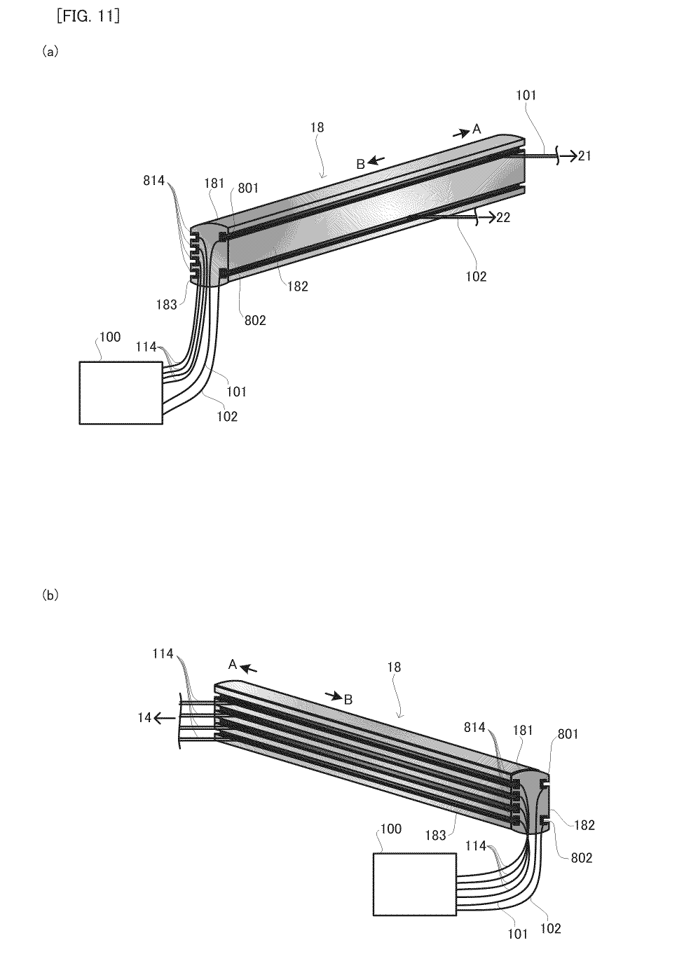

### BRIEF DESCRIPTION OF DRAWINGS

[FIG. 1] FIG. 1 are (a) a top view, (b) a cross sectional view in a straight line LM, and (c) its enlarged cross sectional view, partially showing an information recording/reproducing apparatus 1 which uses a drive apparatus in a first embodiment of the present invention as a feed mechanism of a pickup apparatus.

[FIG. 2] FIG. 2 are top views showing configuration examples of an ultrasonic motor 22 in the first embodiment (a: in a case where a biasing switch 214 is off, and b: in a case where the biasing switch 214 is on).

[FIG. 3] FIG. 3 are top views showing that the ultrasonic motor 22 in the first embodiment drives a pickup apparatus base 14 (a: in a case where a biasing switch 214 is off, and b: in a case where the biasing switch 214 is on).

[FIG. 4] FIG. 4 are (a) a top view, (b) a cross sectional view in a straight line LM, and (c) its enlarged cross sectional view, partially showing the information recording/reproducing apparatus 1 which uses a drive apparatus in a modified example of the first embodiment as the feed mechanism of the pickup apparatus.

[FIG. 5] FIG. 5 are (a) a top view, (b) a cross sectional view in a straight line LM, and (c) its enlarged cross sectional view, partially showing the information recording/reproducing apparatus 1 which uses a drive apparatus in a second embodiment of the present invention as the feed mechanism of the pickup apparatus.

[FIG. 6] FIG. 6 are time charts indicating a drive control signal with respect to the ultrasonic motors 21 and 22 in the second embodiment (a: where only one is driven, b where they are alternately driven, c: where both are driven).

[FIG. 7] FIG. 7 are (a) a top view, (b) a cross sectional view in a straight line LM, and (c) its enlarged cross sectional view, partially showing the information recording/reproducing apparatus 1 which uses a drive apparatus in a third embodiment of the present invention as the feed mechanism of the pickup apparatus.

[FIG. 8] FIG. 8 are (a) a top view, (b) a cross sectional view in a straight line LM, and (c) its enlarged cross sectional view, partially showing the information recording/reproducing apparatus 1 which uses a drive apparatus in a first modified example of the third embodiment as the feed mechanism of the pickup apparatus.

[FIG. 9] FIG. 9 are (a) a top view, (b) a cross sectional view in a straight line LM, and (c) its enlarged cross sectional view, partially showing the information recording/reproducing apparatus 1 which uses a drive apparatus in a second modified example of the third embodiment as the feed mechanism of the pickup apparatus.

[FIG. 10] FIG. 10 are (a) a top view, (b) an enlarged cross sectional view in the vicinity of a guide shaft 18 in a straight line LM, and (c) an enlarged cross sectional view in the vicinity of the guide shaft 18 in a straight line JK, partially showing the information recording/reproducing apparatus 1 which uses a drive apparatus in a fourth embodiment of the present invention as the feed mechanism of the pickup apparatus.

[FIG. 11] FIG. 11 are (a) an enlarged perspective view seen from the upper right and (b) an enlarged perspective view seen from the upper left, partially showing the guide shaft 18, wires 101, 102 and 114 in the fourth embodiment.

### DESCRIPTION OF REFERENCE CODES

1 information recording/reproducing apparatus
14 pickup apparatus base
11 substrate
17, 18 guide shaft
117, 118 side wall
182 plane
21, 22 ultrasonic motor
20 output end
48 fixing part
213 spring-loaded support
100 microprocessor

### BEST MODE FOR CARRYING OUT THE INVENTION

Hereinafter, the best mode for carrying out the invention will be explained in order in each embodiment with reference to the drawings.

### First Embodiment

FIG. 1 are (a) a top view, (b) a cross sectional view in a straight line LM, and (c) its enlarged cross sectional view, partially showing an information recording/reproducing apparatus 1 which uses a drive apparatus in a first embodiment of the present invention as a feed mechanism of a pickup apparatus. Incidentally, the constituents in the other portion of the information recording/reproducing apparatus 1 may be the same as the known constituents, and its detailed structure diagram is omitted, as occasion demands.

As shown in FIG. 1(a) and FIG. 1(b), the information recording/reproducing apparatus 1 is an apparatus for recording and reproducing information with respect to a recording medium 200.

A substrate 11 of the information recording/reproducing apparatus 1 is provided with a hub 16. The hub 16 cramps the recording medium 200 at the center and rotates it at a predetermined linear velocity in response to the torque of a spindle motor (not illustrated).

In the substrate 11, an opening 13 is formed. The opening 13 is shaped to drive a pickup apparatus base 14 in the radial direction of the recording medium 20 from the outer circumferential end to the vicinity of the central part of the recording medium 200.

The pickup apparatus base 14 is a base to be equipped with a pickup apparatus (not illustrated). The pickup apparatus is connected to a microprocessor 100 via a wire 114. In response to a control signal from the microprocessor 100, the pickup apparatus irradiates the recording medium 200 with an information writing or information reading laser beam, and at the same time, the pickup apparatus allows the incidence and detection of reflected light from the recording medium 200, thereby performing information recording and reproduction. The pickup apparatus base 14 has a dent in a circular arc shape fitting the outer shape of the hub 16 so that it can get close to the hub 16. On the side thereof, the pickup apparatus base 14 is provided with bearings 141, 142, and 143 in which a through-bore or a U-shaped groove is formed in accordance with the thickness of the guide shafts 17 and 18. The number of the bearings are preferably three or more from the viewpoint of the balance of the pickup apparatus base 14.

The guide shafts 17 and 18 make a pair, extend in a direction along the radial direction of the recording medium 200 in the opening 13, and are disposed to be substantially parallel to each other. The guide shaft 17 is, for example, a cylinder and its both ends are fixed to the substrate 11 by fixing parts 47. The guide shaft 18 is, for example, a column with a D cut surface as detailed later and its both ends are fixed to the substrate 11 by fixing parts 48.

Ultrasonic motors 21 and 22 are fixed to the pickup apparatus base 14 by a plate-like connection part 15 such that an output end 20 of each ultrasonic motor is in contact with the guide shaft 18. The ultrasonic motor 21 is connected to the microprocessor 100 via a wire 101, and the ultrasonic motor 22 is connected to the microprocessor 100 via a wire 102. The ultrasonic motors 21 and 22 operate in response to a drive control signal from the microprocessor 100. In operation, the ultrasonic motor 21 outputs a driving force in a direction A or a direction B along the extending direction of the guide shaft 18, to the guide shaft 18.

The microprocessor 100 is provided with an arithmetic device and a memory device and transmits information to be recorded to the recording medium 200, or reproduces the read information. Moreover, in the recording or reproduction, the microprocessor 100 operates both or one of the ultrasonic motors 21 and 22 such that the pickup apparatus is at a desired position with respect to the recording medium 200.

As detailed above, according to FIG. 1(a) and FIG. 1(b), the ultrasonic motors 21 and 22 are fixed via the connection part 15 to the pickup apparatus base 14 which is a drive target, and thus, the ultrasonic motors 21 and 22 are translated with the pickup apparatus base 14. Then, there is no change in relative positional relation between the pickup apparatus base 14 and the ultrasonic motor 21 or 22. This makes it possible to prevent the deflection of the guide shaft 18, thereby maintaining more stable drive. At this time, in particular, the plurality of ultrasonic motors 21 and 22 are provided, and thus a sufficient driving force can be ensured. Moreover, each of the ultrasonic motors 21 and 22 is appropriately disposed and is individually controlled by the microprocessor 100, so that it is possible to avoid a loss of the driving force as much as possible.

Moreover, as shown in FIG. 1(c), the guide shaft 18 is, for example, a column with a D cut surface as detailed later. In other words, the guide shaft 18 has a shape based on a cylinder, and in one portion of the side surface, a plane 182 is formed along the extending direction of the guide shaft 18. A curved surface 181 is the remaining side surface. The ultrasonic motor 22 outputs the driving force in the direction A or the direction B, from the output end 20 to a plane 218 of the guide shaft 18. At this time, in particular, the plane 182 of the side surface of the guide shaft 18 and the output end 20 of the ultrasonic motor 22 are in point contact, so that there is no need to adjust them to be parallel to each other.

Next, with reference to FIG. 2, a detailed explanation will be given on a transmission aspect of the driving force, depending on ON/OFF of a biasing switch (or force-applying switch) 214. FIG. 2 are top views showing configuration examples of the ultrasonic motor 22 in the first embodiment.

As shown in FIG. 2(a) and FIG. 2(b), in a case 281 of the ultrasonic motor 22, two plate-like piezoelectric ceramics 291 (piezoelectric element) having short sides 283 and 285 and long sides 287 and 289 are piled and accommodated. In the case 281, an opening 293 is provided on the side of one short side 283 of the plate-like ceramics 291, and the output end 20 which is in contact with the plane 182 of the guide shaft 18 (e.g. a ceramic spacer) is fixed on the short side 283 in the opening 293.

On one surface of the piezoelectric ceramics 291, rectangular electrodes 297, 299, 201, and 203 are plated, and on the rear surface, an electrode covering a substantially entire surface is plated. The electrodes 297 and 203 at diagonal positions are connected by a lead wire 205, and the electrodes 299 and 201 at diagonal positions are connected by a lead wire 207.

Between one long side 289 of the piezoelectric ceramics 291 and the case 281, for example, there are disposed spring-loaded supports 209 made of cylindrical silicon rubber, and they press the other long side 287 of the piezoelectric ceramics 291 against the case 281. The case 281 against which the long side 287 is pressed makes fixed supports 211. The spring-loaded supports 209, the fixed supports 211, and the piezoelectric ceramics 291 can be slid.

Between one short side 285 of the piezoelectric ceramics 291 and the case 281, for example, a spring-loaded support 213 is disposed, and it biases the piezoelectric ceramics 291 toward the plane 182 of the guide shaft 18 via the output end 20. The biasing switch 214 is a mechanism capable of adjusting the bias or applied force by the spring-loaded support 213 in two stages (i.e. ON/OFF) between the spring-loaded support 213 and the case 281. The biasing switch 214 adjusts the bias or applied force by the degree of tightening a bolt, the change of presence and absence of mechanical connection, or the application of a voltage to the piezoelectric element. The surroundings of the opening 293 of the case 281 make a stopper of the piezoelectric ceramics 291 when the short side 283 is biased by the spring-loaded support 213.

According to FIG. 2(a), as the biasing switch 214 is OFF, the plane 182 of the side surface of the guide shaft 18 and the output end 20 of the ultrasonic motor 22 are not in contact. Hence, the output of the ultrasonic motor 22 is not transmitted to the guide shaft 18.

On the other hand, according to FIG. 2(b), as the biasing switch 214 is ON, the plane 182 of the side surface of the guide shaft 18 and the output end 20 of the ultrasonic motor 22 are in point contact in a contact area 218. Hence, the output of the ultrasonic motor 22 is transmitted to the guide shaft 18, and thus the pickup apparatus base 14 can be driven in the direction A or the direction B along the extending direction of the guide shaft 18.

Incidentally, the excitation of the piezoelectric ceramics 291 is performed by an alternating-current (AC) voltage or a pulse voltage with a frequency near a resonance point (e.g. 40 KHz). The time responsiveness of the spring-loaded support 213 is set to be sufficiently slower than the resonance frequency of the piezoelectric ceramics 291.

Next, with reference to FIG. 3, an explanation will be given on an operation principle when the ultrasonic motor 22 outputs the driving force in the direction A or the direction B along the extending direction of the guide shaft 18 from the output end 20 to the guide shaft 18. FIG. 3 are top views showing that the ultrasonic motor 22 in the first embodiment drives the pickup apparatus 14.

As shown in FIG. 3(a), the operation principle for the ultrasonic motor 22 to drive the pickup apparatus base 14 in the direction A is as follows. That is, if a positive pulse is applied to the electrodes 299 and 201 and a negative pulse is applied to the electrodes 297 and 203, then, the piezoelectric ceramics 291 deform such that the long side 287 becomes longer than the long side 289 in each oscillation or vibration, and the output end 20 makes elliptic motion. Here, as described above, the time responsiveness of the spring-loaded support 213 is sufficiently slower than the resonance frequency of the piezoelectric ceramics 291, so that the output end 20 is biased to the plane 182 of the guide shaft 18 only in one direction of the oscillation by the spring-loaded support 213 and is separated from the plane 182 of the guide shaft 18 in the opposite direction of the oscillation. In this manner, the oscillation of the piezoelectric ceramics 291 is converted into the driving force in one direction (the direction B in case of FIG. 3(a)). Then, due to a friction force caused by the bias or applied force of the spring-loaded support 213, the driving force in the direction B is outputted to the guide shaft 18 from the output end 20 of the ultrasonic motor 22. This reaction allows the translation of the ultrasonic motor 22 and the pickup apparatus base 14 in the direction A. In other words, the ultrasonic motor 22 drives the pickup apparatus base 14 in the direction A. At this time, the ultrasonic motor 22 obtains a large driving force at low speed in comparison with an electromagnetic motor, and the driving force of the piezoelectric ceramics 291 is directly transmitted to the plane 182 of the guide shaft 18 by the friction force. Thus, a gear mechanism for converting rotation into a linear direction is not required.

On the other hand, as shown in FIG. 3(b), the operation principle for the ultrasonic motor 22 to drive the pickup apparatus base 14 in the direction B is as follows. That is, as opposed to FIG. 3(a), if a negative pulse is applied to the electrodes 299 and 201 and a positive pulse is applied to the electrodes 297 and 203, the piezoelectric ceramics 291 deform such that the long side 287 becomes shorter than the long side 289 in each oscillation or vibration, and the output end 20 makes elliptic motion in the opposite direction in case of FIG. 3(a). Then, in the same manner, the oscillation of the piezoelectric ceramics 291 is converted into the driving force in one direction (the direction A in case of FIG. 3(b)). Then, due to a friction force caused by the bias or applied force of the spring-loaded support 213, the driving force in the direction A is outputted to the guide shaft 18 from the output end 20 of the ultrasonic motor 22. This reaction allows the translation of the ultrasonic motor 22 and the pickup apparatus base 14 in the direction B.

As detailed above, according to FIG. 3, the ultrasonic motor 22 can output the driving force in the direction A or the direction B along the extending direction of the guide shaft 18 from the output end 20 to the guide shaft 18. Incidentally, the ultrasonic motor 21 basically has the same structure as well.

Next, with reference to a modified example of the first embodiment shown in FIG. 4, an additional advantage of the first embodiment shown in FIG. 1 will be detailed. FIG. 4 are (a) a top view, (b) a cross sectional view in a straight line LM, and (c) its enlarged cross sectional view, partially showing the information recording/reproducing apparatus 1 which uses a drive apparatus in the modified example of the first embodiment as the feed mechanism of the pickup apparatus.

As shown in FIG. 4, in the modified example of the first embodiment, the layout of the wire 101 connected to the ultrasonic motor 21 and the wire 102 connected to the ultrasonic motor 22 is different from that in the first embodiment shown in FIG. 1. In other words, in FIG. 4, each of the wires 101 and 102 is connected to the microprocessor 100 without being via the pickup apparatus base 14, apart from the wire 114 connected to the not-illustrated pickup apparatus. Then, the ultrasonic motors 21 and 22 are translated when the pickup apparatus base 14 is driven. Incidentally, the wires 101, 102, and 114 are typically flexible wires which can expand and contract or bend. Then, there is a need not only to reserve a space in which the wire 114 can expand and contract but also to separately reserve a space in which the wires 101 and 102 can expand and contract. If a sufficient space is not reserved, then, the wires 101 and 102 are likely entangled in the guide shaft 18 or get stuck between the substrate 11 and the ultrasonic motor 22, and a desired driving force cannot be obtained.

In contrast, as shown in FIG. 1, in the first embodiment, the wires 101 and 102 are unified with the wire 114 connected to the not-illustrated pickup apparatus, and the wires are connected to the microprocessor 100 together via the pickup apparatus base 14 from the rear thereof (i.e. the direction B side of the pickup apparatus base 14 in FIG. 1(a)). Then, it is possible to share the space in which the wire 114 can expand and contract and the space in which the wires 101 and 102 can expand and contract, in the rear of the pickup apparatus base 14.

Incidentally, the wires 101 and 102 may be firstly fixed to the connection part 15, and then connected to the microprocessor 100 via the connection part 15 and the pickup apparatus base 14. Then, the possibility that the wires 101 and 102 are entangled in the wire guide shaft 18 is further reduced in comparison with a case where the wires are not fixed to the connection part 15.

As detailed above, according to FIG. 1 to FIG. 4, it is shown that devising the layout of the wires 101 and 102 can provide a reduced space the wires occupy, thereby increasing the degree of freedom of the layout and provide a desired driving force without the wires entangled in the guide shaft 18 or the like.

### Second Embodiment

FIG. 5 are (a) a top view, (b) a cross sectional view in a straight line LM, and (c) its enlarged cross sectional view, partially showing the information recording/reproducing apparatus 1 which uses a drive apparatus in a second embodiment of the present invention as the feed mechanism of the pickup apparatus. Incidentally, the detailed explanation of the same constituents as those of the first embodiment and the constituents that can be the same as the known ones is omitted, as occasion demands.

As shown in FIG. 5(a) to FIG. 5(c), in the second embodiment, the layout of the ultrasonic motors 21 and 22 is different from the first embodiment shown in FIG. 1. That is, in the first embodiment shown in FIG. 1, the ultrasonic motors 21 and 22 are biased only to one plane of a plane 172 of a guide shaft 17 and the plane 182 of the guide shaft 18.

In contrast, in the second embodiment shown in FIG. 5, the ultrasonic motors are biased to the both planes. Moreover, a direction in which the ultrasonic motor 21 is biased to the plane 172 of the guide shaft 17 is opposite to a direction in which the ultrasonic motor 22 is biased to the plane 182 of the guide shaft 18. In this condition, the pickup apparatus base 14 and the ultrasonic motors 21 and 22 are translated with it propped between the two guide shafts 17 and 18 which make a pair. This makes it possible to output a proper balance of the driving force to the two guide shafts 17 and 18 which make a pair.

Moreover, as shown in FIG. 5(a) to FIG. 5(c), in the second embodiment, the ultrasonic motors 21 and 22 are located on the pickup apparatus base 14 side with respect to the guide shafts 17 and 18, and typically, the ultrasonic motors 21 and 22 are built in the pickup apparatus base 14 or the not-illustrated pickup apparatus. Then, in comparison with the first embodiment shown in FIG. 1, the occupied space outside the pickup apparatus base 14 is reduced. In addition, it is advantageous in unifying the wires 101 and 102 with the wire 114 connected to the not-illustrated pickup apparatus.

Moreover, each of the ultrasonic motors 21 and 22 built in the pickup apparatus base 14 is caught between the plane 172 and the plane 182. Then, as shown in FIG. 5(c), if each of the output ends 20 of the ultrasonic motors 21 and 22 is planar and is in plane contact with respective one of the planes 172 and 182, then, it is possible to maintain the parallel, good contact state.

Next, an explanation will be given on the control of the ultrasonic motors 21 and 22 by the microprocessor 100 in the second embodiment.

FIG. 6 are time charts indicating a drive control signal with respect to the ultrasonic motors 21 and 22 in the second embodiment (a: where only one is driven, b where they are alternately driven, c: where both are driven). Incidentally, the drive control signal for the ultrasonic motor 21 is shown by a dotted line, and the drive control signal for the ultrasonic motor 22 is shown by an alternate long and short dash line.

FIG. 6(a) shows each drive control signal for respective one of the ultrasonic motors in the case where only the ultrasonic motor 21 of the ultrasonic motors 21 and 22 is driven.

FIG. 6(b) shows each drive control signal for respective one of the ultrasonic motors in the case where the ultrasonic motors 21 and 22 are alternately driven. The drive in this manner allows stable drive to be maintained while power consumption is kept down to the same degree in comparison with the case of FIG. 6(a). In addition, the microprocessor 100 may turn off the biasing switch 214 so as not to apply a force to (or not to bias) the ultrasonic motor that does not output the driving force from among the ultrasonic motors 21 and 22. Then, it is possible to avoid the output end 20 being worn away unnecessarily. Incidentally, for the waveform of each drive control signal, not only a square wave shown in FIG. 6(b) but also a sine wave and a ramp wave whose phase is shifted by half wavelength may be used.

FIG. 6(c) shows each drive control signal for respective one of the ultrasonic motors in the case where both the ultrasonic motors 21 and 22 are driven. The drive in this manner improves the overall driving force in comparison with the cases of FIG. 6(a) and FIG. 6(b).

### Third Embodiment

FIG. 7 are (a) a top view, (b) a cross sectional view in a straight line LM, and (c) its enlarged cross sectional view, partially showing the information recording/reproducing apparatus 1 which uses a drive apparatus in a third embodiment of the present invention as the feed mechanism of the pickup apparatus. Incidentally, the detailed explanation of the same constituents as those of the first embodiment and the constituents that can be the same as the known ones is omitted, as occasion demands.

As shown in FIG. 7(a) to FIG. 7(c), in the third embodiment, the aspect of the guiding device is different from the first embodiment shown in FIG. 1 and the second embodiment shown in FIG. 5. That is, both the first embodiment shown in FIG. 1 and the second embodiment shown in FIG. 5 use the guide shafts 17 and 18 as the guiding device.

In contrast, in the third embodiment shown in FIG. 7, the side walls of the substrate 11 are used as the guiding device. Here, the side walls of the substrate 11 have two planes 117 and 118 which are mutually parallel and which are formed in a direction along a predetermined direction in which it is desired to drive the pickup apparatus base 14. By this, the guide shafts 17 and 18 and their fixing parts 47 and 48 or the like are no longer required, so that the number of parts is reduced and the structure is simplified. Moreover, as shown in FIG. 7(c), if the side walls of the substrate 11 are formed in a U-shape and are set to catch the pickup apparatus base 14 with the ultrasonic motors 21 and 22 built therein from the above and below, then, a shift of the position of the pickup apparatus base 14 can be also prevented.

Next, the arrangement of the ultrasonic motors when the number of the ultrasonic motors is increased will be examined with reference to modified examples of the third embodiment shown in FIG. 8 and FIG. 9. In FIG. 8 and FIG. 9, the information recording/reproducing apparatus 1 is provided with four ultrasonic motors 21, 22, 23, and 24.

FIG. 8 are (a) a top view, (b) a cross sectional view in a straight line LM, and (c) its enlarged cross sectional view, partially showing the information recording/reproducing apparatus 1 which uses a drive apparatus in a first modified example of the third embodiment as the feed mechanism of the pickup apparatus.

As shown in FIG. 8(a), in the information recording/reproducing apparatus 1 in the first modified example of the third embodiment, the ultrasonic motors 21 and 23 are arranged side by side in a direction along the extending direction of the plane 117 (in other words, in the direction A or the direction B) such that each output end 20 is in contact with the plane 117. On the other hand, the ultrasonic motors 22 and 24 are arranged side by side in a direction along the extending direction of the plane 118 (in other words, in the direction A or the direction B) such that each output end 20 is in contact with the plane 118. By this, as shown in FIG. 8(b) and FIG. 8(c), it is possible to limit or control the thickness of the information recording/reproducing apparatus 1 in a direction crossing the direction A or the direction B.

FIG. 9 are (a) a top view, (b) a cross sectional view in a straight line LM, and (c) its enlarged cross sectional view, partially showing the information recording/reproducing apparatus 1 which uses a drive apparatus in a second modified example of the third embodiment as the feed mechanism of the pickup apparatus.

As shown in FIG. 9(b) and FIG. 9(c), in the information recording/reproducing apparatus 1 in the second modified example of the third embodiment, the ultrasonic motors 21 and 23 are arranged in piles in a direction crossing the extending direction of the plane 117 (in other words, in the direction A or the direction B) such that each output end 20 is in contact with the plane 117. On the other hand, the ultrasonic motors 22 and 24 are arranged in piles in a direction crossing the extending direction of the plane 118 (in other words, in the direction A or the direction B) such that each output end 20 is in contact with the plane 118. By this, as shown in FIG. 9(a), it is possible to improve the driving force per unit length in the direction along the direction A or the direction B as well as reducing the occupied area by the four ultrasonic motors 21, 22, 23, and 24 viewed from the upper surface.

### Fourth Embodiment

FIG. 10 are (a) a top view, (b) an enlarged cross sectional view in the vicinity of a guide shaft 18 in a straight line LM, and (c) an enlarged cross sectional view in the vicinity of the guide shaft 18 in a straight line JK, partially showing the information recording/reproducing apparatus 1 which uses a drive apparatus in a fourth embodiment of the present invention as the feed mechanism of the pickup apparatus. FIG. 11 are (a) an enlarged perspective view seen from the upper right and (b) an enlarged perspective view seen from the upper left, partially showing the guide shaft 18, the wires 101, 102 and 114 in the fourth embodiment. Incidentally, the detailed explanation of the same constituents as those of the first embodiment and the constituents that can be the same as the known ones is omitted, as occasion demands.

As shown in FIG. 10(a), in the fourth embodiment, the layout of the wires 101, 102, and 114 is different from the first embodiment shown in FIG. 1.

That is, in the first embodiment shown in FIG. 1, the wires 101 and 102 are unified with the wire 114 behind the pickup apparatus base 14. In this structure, all the wires 101, 102, and 114 are typically flexible wires which can expand and contract or bend. Thus, every time the pickup apparatus base 14 is driven in the direction A or the direction B, the wires 101, 102, and 114 expand and contract or bend behind the pickup apparatus base 14. If so, then, there is a need to reserve an appropriate space in which the wires 101, 102, and 114 can expand and contract or bend.

In contrast, in the fourth embodiment shown in FIG. 10(a), the wires 101 and 102 and the wires 114 are unified on the guide shaft 18 disposed on the side of the pickup apparatus base 14. In other words, in this structure, not all the wires 101, 102, and 114 are flexible wires, and the guide shaft 18 functions as a so-called wiring duct rail. Then, even if the pickup apparatus base 14 is driven in the direction A or the direction B, the wires 101, 102, and 114 do not expand and contract or bend behind the pickup apparatus base 14. The detailed structure will be supplemented with reference to FIG. 10(b), FIG. 10(c), FIG. 11(a), and FIG. 11(b).

Firstly, as shown in FIG. 10(b), on the side surface of the guide shaft 18, there are formed not only the plane 182 but also a plane 183 along the extending direction of the guide shaft 18 on the opposite side of the plane 182. Moreover, on the plane 182 of the guide shaft 18, there are formed groove portions for accommodating conductor parts 801 and 802 made of an electrical conducting material, along the extending direction of the guide shaft 18, with their positions in the direction crossing the extending direction of the guide shaft 18 distant from each other. Then, as shown in FIG. 10(a) and FIG. 11(a), each of the tips of the wires 101 and 102 is engaged with respective one of the conductor parts 801 and 802 slidably in the extending direction of the guide shaft 18 (i.e. the direction A or the direction B). Moreover, even on the plane 183 of the guide shaft 18, there are formed a plurality of groove portions for accommodating conductor parts 814 made of an electrical conducting material, along the extending direction of the guide shaft 18, with their positions in the direction crossing the extending direction of the guide shaft 18 distant from each other. Here, as shown in FIG. 10(c), in the pickup apparatus base 14, there is formed the bearing 143 in which a through-bore or a U-shaped groove is formed, wherein the bore or the groove has substantially the same shape as that of the cross section of the guide shaft 18 and is slightly larger than the cross section. The guide shaft 18 penetrates the bearing 143, and one ends of the wires 114 with the other ends connected to the not-illustrated pickup apparatus gather on the bearing 143. Then, as shown in FIG. 10(c) and FIG. 11(b), each of the tips of the wires 114 is engaged with respective one of the conductor parts 814 slidably in the extending direction of the guide shaft 18 (i.e. the direction A or the direction B). Incidentally, preferably, an area other than the groove portions of the side surface of the guide shaft 18 and an area of the bearing 143 in contact with the guide shaft 18 are coated with an insulator in order to prevent short between the conductor parts.

As detailed above, according to the fourth embodiment, even if the pickup apparatus base 14 is driven in the direction A or the direction B, each of the tips of the wires 101, 102, and 114 is slid in the extending direction of the guide shaft 18 (i.e. the direction A or the direction B) with it engaged with respective one of the conductor parts 801, 802, and 814. Then, there is no need to expand and contract the wires 101, 102, and 114, and thus there is no need to reserve a space for it.

Incidentally, in the fourth embodiment, the tips of the wires 114 are engaged slidably on the guide shaft 18 side, but may be also engaged slidably on the guide shaft 17 side. This makes it possible to avoid a higher concentration of the conductor parts 801, 802, and 814 on the guide shaft 18. Moreover, if not the guide shaft 17 and 18 but the side wall of the substrate 11 is used as the guiding device, the conductor parts 801, 802, and 814 may be formed on the side wall of the substrate 11.

Incidentally, in each of the aforementioned embodiments,

the “pickup apparatus base 14” is one example of the “driven object” of the present invention;
the “substrate 11” is one example of the “substrate” of the present invention;
the “guide shafts 17 and 18” and the “side walls 117 and 118” are one example of the “plurality of guiding devices” of the present invention;
the “direction A” and the “direction B” are one example of the “direction along the extending direction of the guiding device” of the present invention;
the “plane 182” is one example of the “side surface of the guiding device” of the present invention and one example of the “plane” formed “in the extending direction of the guiding device”;
the “ultrasonic motors 21 and 22” is one example of the “plurality of outputting devices” of the present invention;
the “output end 20” is one example of the “output end” of the present invention;
the “connection part 15” is one example of the “connecting device” of the present invention;
the “spring-loaded support 213” is one example of the “biasing device” of the present invention; and
the “microprocessor 100” is one example of the “controlling device” of the present invention.

Incidentally, the present invention is not limited to the aforementioned embodiments, but various changes may be made, if desired, without departing from the essence or spirit of the invention which can be read from the claims and the entire specification. An apparatus, which involves such changes, is also intended to be within the technical scope of the present invention.

### INDUSTRIAL APPLICABILITY

The present invention can be used for a drive apparatus using an ultrasonic motor, which drives an optical pickup and another driven object in an extending direction of a guide shaft.

1-11. (canceled)

12. A drive apparatus for driving a driven object in a predetermined direction, said drive apparatus comprising:
a plurality of guiding devices which are fixed to a substrate and each of which extends in the predetermined direction;
a plurality of outputting devices each of which outputs a driving force in a direction along the extending direction of said guiding devices from an output end to at least one of said plurality of guiding devices and which are translated with the driven object by being connected to the driven object;
a controlling device for controlling each of said outputting devices such that said outputting devices outputs the driving force in desired timing; and
a biasing device for biasing said plurality of outputting deices toward at least one of said plurality of guiding devices,
said biasing device having:
a slidable piezoelectric element; and
a biasing switch capable of adjusting a bias force or an applied force of said biasing device,
time responsiveness of said biasing device being slower than resonance frequency of the piezoelectric element.

13. The drive apparatus according to claim 12, wherein said plurality of outputting deices output the driving force to two of said plurality of guiding devices which make a pair.

14. The drive apparatus according to claim 13, wherein
said biasing device biases said plurality of outputting deices toward side surfaces of the two guiding devices which make a pair, and
a direction in which said plurality of outputting deices are biased toward the side surface of one of the two guiding devices which make a pair is opposite to a direction in which said plurality of outputting deices are biased toward the side surface of the other guiding device.

15. The drive apparatus according to claim 13, wherein each of the two guiding devices which make a pair is a guide shaft in which a plane is formed in the extending direction of said guiding devices in at least one portion of the side surface.

16. The drive apparatus according to claim 13, wherein each of the two guiding devices which make a pair is a side wall of the substrate having two planes which are parallel to each other and which are formed in a direction along the predetermined direction.

17. The drive apparatus according to claim 12, wherein said controlling device controls each of said plurality of outputting devices such that said plurality of outputting devices output the driving force all together.

18. The drive apparatus according to claim 12, wherein said controlling device controls each of said plurality of outputting devices such that said plurality of outputting devices output the driving force alternately.

19. The drive apparatus according to claim 18, wherein said controlling device also controls said biasing device not to bias an outputting device that does not the driving force when said plurality of outputting devices output the driving force alternately.

20. The drive apparatus according to claim 12, wherein said plurality of outputting devices are arranged side by side in the direction along the extending direction of said guiding devices.

21. The drive apparatus according to claim 12, wherein said plurality of outputting devices are arranged in piles in a direction crossing the extending direction of said guiding devices.

22. An information recording/reproducing apparatus comprising a drive apparatus for driving a driven object in a predetermined direction, said drive apparatus comprising: a plurality of guiding devices which are fixed to a substrate and each of which extends in the predetermined direction; a plurality of outputting devices each of which outputs a driving force in a direction along the extending direction of said guiding devices from respective one of output ends to at least one of said plurality of guiding devices and which are translated with the driven object by being connected to the driven object; a controlling device for controlling each of said outputting devices such that said outputting devices outputs the driving force in desired timing, a biasing device for biasing said plurality of outputting deices toward at least one of said plurality of guiding devices, said biasing device having: a slidable piezoelectric element; and a biasing switch capable of adjusting a bias force or an applied force of said biasing device, time responsiveness of said biasing device being slower than resonance frequency of the piezoelectric element, wherein
said outputting devices are ultrasonic motors,
the driven object is a pickup apparatus, and
said drive apparatus is used as a feed mechanism of the pickup apparatus.
